(19) United States
(12) Patent Application Publication
(10) Pub. No.: US 2005/0274213 A1
(43) Pub. Date: Dec. 15, 2005

(54) Actuator assembly for suspension

(75) Inventor: Young-Kwang Kim, Kyunggi-do (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Yongin-shi (KR)

(21) Appl. No.: 10/997,929

(22) Filed: Nov. 29, 2004

(30) Foreign Application Priority Data
Jun. 9, 2004 (KR) 10-2004-0042073

(51) Int. Cl. F16H 35/00

(52) U.S. Cl. 74/380

(57) ABSTRACT

An actuator assembly for a suspension, especially, which can be smoothly operated and has an excellent endurance because a yoke is so mounted as to be rotatable around lever and be movable up- and downwards therefrom, so that a twisted angle can be absorbed, even though the actuator and the lever are twisted by the position tolerance generated during being assembled.

### RELATED APPLICATIONS

The present disclosure relates to subject matter contained in priority Korean Application No. 10-2004-0042073, filed on Jun. 09, 2004, which is herein expressly incorporated by reference in its entirety.

### BACKGROUND OF THE INVENTION

1. Field of the Invention

The present invention relates to an actuator assembly for a suspension, specially to an actuator assembly for a suspension, which has a yoke being so mounted as to be rotatable around a lever and be movable up-and downwards therefrom.

2. Description of the Related Art

In general, a suspension has to satisfy the basic conditions to secure the controllability and stability of vehicles on turning or braking. To satisfy these conditions, the behavior of wheels accompanied by suspension geometry acts as a very important factor, and especially camber and toe do have many effects on the straight driving stability and the turning safety of vehicles. This is closely connected with the rolling of a body.

This actuator assembly for a suspension, which can properly change the camber and toe according to the running conditions of vehicles, is disclosed in Korean Patent Publication No. 2003-0017668.

The embodiment to carry out such a Prior Art is disclosed in FIGS. 1 and 2. As shown in FIGS. 1 and 2, a yoke 21 and a bracket 23 are arranged on the lever 20 which is fixed on sub-frame through a hinge axis 27. An auxiliary link 10, which is connected with the bracket 23 by a mounting bush 11, is mounted on a control arm or knuckle. The mounting part 33 of an actuator rod 31 is mounted on the yoke 21 in which the slot 21a is equipped, and a pin 25 is inserted into the slots 21a.

For this actuator assembly for the suspension constituted in a preceding manner, as shown in FIG. 2, the lever 20 connected with an actuator 30, and the auxiliary link 10 are moved in the direction of the arrows according to a forward/backward operation of the actuator rod 31. Herewith, the control arm or the knuckle connected with the auxiliary link, are moved and then the toe of the rear wheels can be adjusted.

Another embodiment of the prior actuator assembly for a suspension is disclosed in FIG. 3. As shown in FIG. 3, the prior actuator assembly includes: a lever 20′ connected with a sub-frame through hinge axis 27 and in which a yoke 21 is equipped into; an actuator 30 connected by the yoke 21; and an auxiliary link 10 connected with one side of the lever 20′ with a mounting bush 11.

In the actuator assembly, the right and left straight reciprocating motion of the actuator 30 is converted into the rotating movement by the hinge axis 27 of the lever 20′, and the rotating movement again into the up and down linear movement of the auxiliary link 10. Accordingly, if the reference length of the knuckle 40 connected with the auxiliary link 10 is varied, the knuckle 40 is rotated and the toe angle is also varied.

The structure and the operation of the actuator assembly are almost identical with those of the above-described prior art, and just the shape of the lever shows a little difference, but its operation is almost same.

However, the actuator assembly for suspension with preceding configurations has following problems:

When the actuator 30 and the lever 20 or 20′ are mounted on the sub-frame, if the operating direction of the actuator rod 31 is deviated, and the hinge axis 27 of the lever 20 or 20′ is twisted because of the position deviation, then it can have a bad effect on the performance and endurance of whole systems.

In other words, when the assembly tolerance is happened after the actuator 30 and the lever 20 and 20′ have been assembled on the sub-frame, the deviation in up and down or right and left direction can be absorbed because of the slots 21a of the yoke and the pin 25 inserted into the slots 21a, but it can be problematic that the structure to allow the smooth of the lever 20 and 20′ by absorbing the twist is not provided when the twist is generated.

### SUMMARY OF THE INVENTION

To solve the above-indicated problems, it is, therefore, an object of the present invention to provide an actuator assembly for a suspension having smooth operation performance and excellent endurance, so that the absorption of the up and down deviation generated on assembling the actuator and the lever, is improved, and also, the better absorption of the twisted angle is allowed, even though the actuator and the lever are twisted by the position tolerance generated during being mounted on the sub frame.

Another abject of the present invention is to provide an actuator assembly for a suspension by which the stress concentration can be relaxed, and, accordingly, the endurance be improved.

To achieve the above object, there is provided an actuator assembly for a suspension which includes of a lever being hinged-fixed on the sub-frame and having a yoke thereon; an actuator connected with the yoke; and an auxiliary link whose one end is coupled with the lever, wherein the yoke is so mounted as to be rotatable around the lever and movable up- and downwards therefrom.

According to this configuration, the deviation in the up and down direction can be more absorbed, even though it is caused on assembling the actuator and the lever.

Besides, the actuator assembly can be smoothly operated and have an excellent endurance, because, even thought the actuator and the lever are twisted by the position tolerance generated on being mounted on the sub-frame, a twisted angle can be absorbed.

In the above-mentioned configuration, a yoke mounting, having a bearing within, is formed on the lever, and the yoke is preferably mounted on the yoke mounting.

Moreover, an insert hole of the yoke is roundly punched, and an actuator rod is surface-contacted with the yoke in a fixing hole with a pin, so that the stress concentration can be relaxed and the endurance be improved

### BRIEF DESCRIPTION OF THE DRAWINGS

The above aspects and features of the present invention will be more apparent by describing certain embodiments of the present invention with reference to the accompanying drawings, in which:

FIG. 1 is an exploded perspective view of a conventional actuator assembly for a suspension;

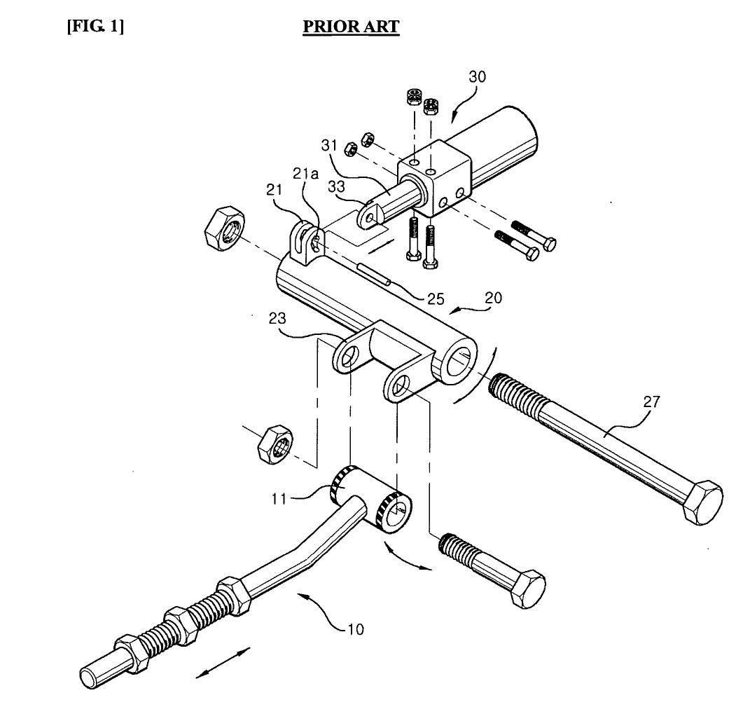

FIG. 2 is an operating state diagram of FIG. 1.

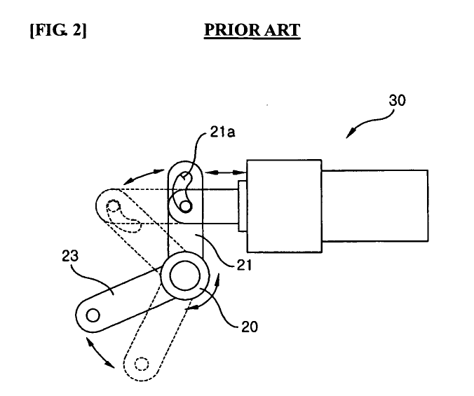

FIG. 3 is an assembly perspective view of other conventional actuator assembly for a suspension;

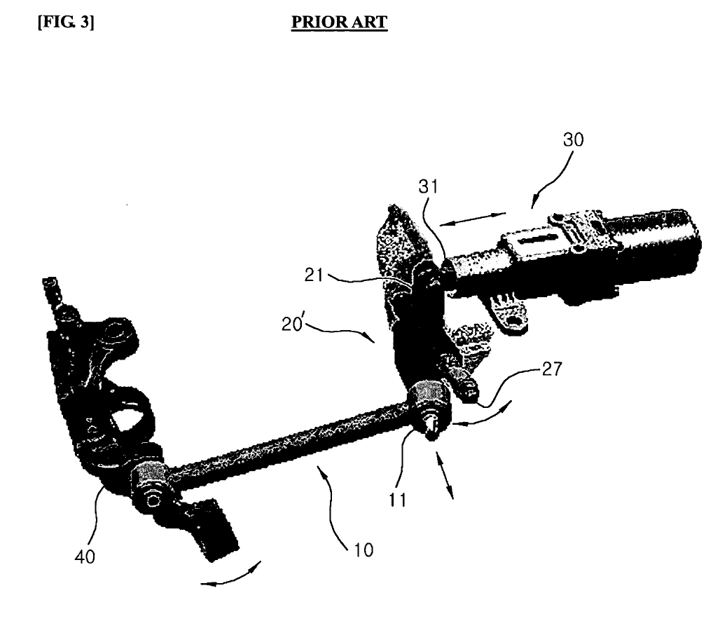

FIG. 4 is an exploded perspective view of an actuator assembly for a suspension in accordance with the preferred embodiment of the present invention; and

FIG. 5 is an assembly cross-section view of FIG. 4.

### DETAILED DESCRIPTION OF THE PREFERRED EMBODIMENTS

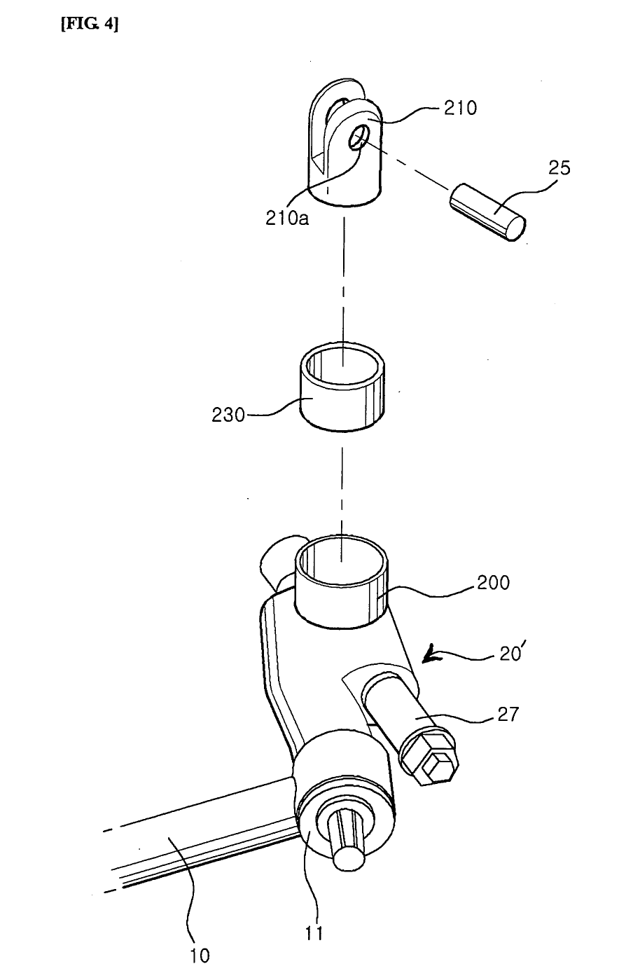

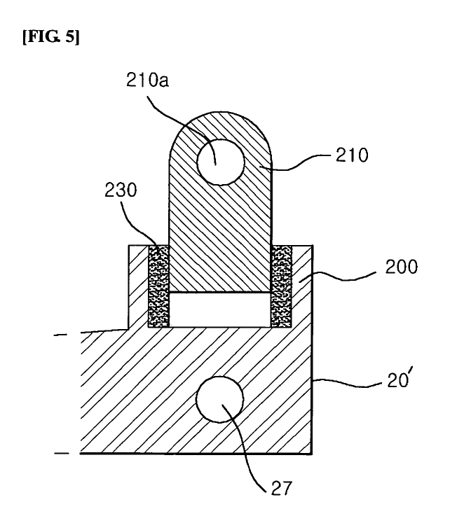

As shown in FIGS. 4 and 5, a preferred embodiment according to the present invention provides the following constitution:

The actuator assembly for the suspension includes: a lever 20′ having a yoke 210 thereon, an actuator(not illustrated) connected with the yoke 210, and an auxiliary link 10 whose one end is coupled with the lever 20′.

The lever 20′, as explained according to the Prior Art, is hinged-connected with sub-frame by hinge axis 27.

A mounting bush 11 of the auxiliary link 10 is arranged on the one side of the lever 20′.

While, a round-shaped yoke mounting 200 is arranged on the other side of the lever 20′, so that the yoke 210 can be mounted thereon.

A bearing 230 is inserted into the yoke mounting 200.

Here, the various kinds of bearings, like ball bearing and roller bearing, etc. can be used for the bearing 230, but an attention shall be paid that the bearing is simplified illustrated in the drawings.

In this way, after the bearing 230 is inserted, the yoke 210 is inserted. At this time, the yoke 210 can be moved in the up and down direction from the yoke mounting 200.

Herein, once the setting-up of the actuator assembly is completed, the yoke 210 can never be deviated from the yoke mounting 200 and also there is no problem with stability because the actuator and the lever 20′ are fixed on the sub-frame.

A round insert hole 210a is punched on the yoke 210, an actuator rod is inserted into the yoke 210, a pin 25 is coupled with the insert hole 210a, and therefore the actuator is connected with the yoke 210.

Because the operation of the actuator assembly constituted as above is just the same as that of the Prior Art, the above-mentioned conventional technique is referred and the following description is limited to the characteristic operation effect of the present invention.

The bearing 230 is arranged on the outer surface of the yoke 210, and inserted into the yoke mounting 200 of the lever 20′, and the yoke 210 is rotatable.

Moreover, because the yoke 210 is so mounted as to be movable in the up and down direction from the yoke mounting 200, when the deviation is generated on assembling, the actuator and the lever 20′ can be more absorbed.

Besides, because a twisted angle can be more absorbed even though the actuator and the lever 20′ are twisted by the position tolerance generated on being mounted on the sub frame, the actuator assembly can be smoothly operated and have the an excellent endurance.

Meanwhile, because the insert hole 210a of the yoke 210 is roundly punched and the actuator rod is surface-contacted with the yoke 210 in the fixing hole with the pin 25, the stress concentration can be relaxed and also the endurance be improved.

As above-mentioned, while the invention has been shown and described with reference to certain preferred embodiments thereof, it will be understood by those skilled in the art that various changes in form and details may be made therein without departing from the spirit and scope of the invention as defined by the appended claims.

As above explained, the actuator assembly for a suspension according to the present invention provides following effects:

Above all, because the yoke is so mounted as to be rotatable around the lever and movable in the up and down direction therefrom, the up- and downward deviation generated on assembling the actuator and the lever can be more absorbed.

Besides, because, even though the actuator and the lever are twisted by the position tolerance generated on being mounted on the sub frame, the twisted angle can be more absorbed, the actuator assembly can be smoothly operated and have an excellent endurance.

Secondly, Because the insert hole of the yoke is roundly punched, and so, the actuator rod is surface-contacted with the yoke in a fixing hole with the pin, the stress concentration can be relaxed and the endurance be improved.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. An actuator assembly for a suspension comprising:
a lever hingedly connectable with a sub frame and having a yoke mounted thereon;
an actuator connectable with the yoke; and
an auxiliary link having one end connectable with the lever;
wherein the yoke is configured to be mounted so as to be rotatable around the lever and movable up- and downwards with respect thereto.

2. The actuator assembly according to a claim 1, wherein a yoke mounting having a bearing within is provided on the lever, and the yoke is mounted on the yoke mounting.

3. The actuator assembly according to a claim 1, wherein an insert hole of the yoke is round.

4. The actuator assembly according to a claim 2, wherein an insert hole of the yoke is round.
